(19) United States
(12) Patent Application Publication
(10) Pub. No.: US 2006/0214424 A1
(43) Pub. Date: Sep. 28, 2006

(54) Coupling for faucet

(76) Inventor: Joon Wook Nam, Kijang-Kun (KR)

Correspondence Address: ST. ONGE STEWARD JOHNSTON & REENS, LLC, 986 BEDFORD STREET, STAMFORD, CT, 06905-5619, US

(21) Appl. No.: 11/441,433

(22) Filed: May 25, 2006

Related U.S. Application Data
(63) Continuation of application No. PCT/KR04/03072, filed on Nov. 26, 2004.

(30) Foreign Application Priority Data
Nov. 27, 2003 (KR) 20-2003-0037628

(51) Int. Cl. F16L 25/00

(52) U.S. Cl. 285/386

(57) ABSTRACT

Disclosed is a coupling for a faucet capable of keeping watertight even when high hydraulic pressure is generated at a connection between a faucet and a tube. The coupling faucet includes a male coupler 10 installed to an outer periphery of a discharge pipe of a faucet, and having a closed cylindrical upper portion, an opened cylindrical bottom, and an opening 12 formed at a side wall for receiving the discharge pipe of the faucet; a connector 20 interposed between the discharge pipe and the male coupler, and having an opened cylindrical upper portion, a slot 22 formed at an upper portion thereof corresponding to the opening 12 of the male coupler 10 for receiving the discharge pipe, and a fitting portion 24 formed at a lower portion of the connector to be coupled to a tube; and a cylindrical female coupler 30 provided on an inner periphery thereof with a threaded portion 32 which is engaged to a threaded portion 14 of the male coupler 10, and having a circular rim 34 formed at a lower inside.

### CROSS-REFERENCE TO RELATED APPLICATIONS

The present application is a continuation of pending International Patent Application PCT/KR2004/003072 filed on Nov. 26, 2004 which designates the United States and claims priority of Korean Patent Application No. 20-2003-0037628 filed on Nov. 27, 2003.

### FIELD OF THE INVENTION

The present invention relates to a coupling for a faucet, and more particularly, to a faucet coupling capable of keeping watertight even when high hydraulic pressure is generated at a connection between a faucet and a tube.

### BACKGROUND OF THE INVENTION

In general, washing machines or water spraying machines are connected to a faucet through a tube to use service water. In this case, the washing machine or water spraying machine controls flow of the service water while a valve for the faucet is opened. When the service water does not flow into the machine, high hydraulic pressure is generated at the faucet and the tube. Therefore, a coupling having a strong fastening force is utilized at a connection between the faucet and the tube.

Such a coupling includes an upper portion coupled to an outer periphery of the faucet by fastening at least four screws to the faucet along an outer periphery of a body, a rubber packing positioned in the upper portion, particular, since the fastening force is gradually weakened due to the hydraulic pressure, the connected portions are frequently loosened to leak the water.

The inventor has proposed a coupling for a faucet having a strong fastening force to solve the above problems (Korean Utility Model Registration No. 302196). The coupling has a drawback in that since its construction is complicated its productivity is low.

### SUMMARY OF THE INVENTION

Therefore, an object of the present invention is to solve the problems involved in the prior art, and to provide a coupling for a faucet capable of keeping watertight even when high hydraulic pressure is generated at a connection between a faucet and a tube.

Another object of the preset invention is to provide a simple coupling for a faucet capable of being easily utilized and improving its productivity.

In order to accomplish the above and other objects, there is provided a coupling faucet comprising: a male coupler installed to an outer periphery of a discharge pipe of a faucet, and having a closed cylindrical upper portion, an opened cylindrical bottom, and an opening formed at a side wall for receiving the discharge pipe of the faucet; a connector interposed between the discharge pipe and the male coupler, and having an opened cylindrical upper portion, a slot formed at an upper portion thereof corresponding to the opening of the male coupler for receiving the discharge pipe, and a fitting portion formed at a lower portion of the connector to be coupled to a tube; and a cylindrical female coupler provided on an inner periphery thereof with a threaded portion which is engaged to a threaded portion of the male coupler, and having a circular rim formed at a lower inside.

### BRIEF DESCRIPTION OF THE DRAWINGS

The above objects, other features and advantages of the present invention will become more apparent by describing the preferred embodiment thereof with reference to the accompanying drawings, in which:

FIG. 1 is an exploded perspective view of a faucet coupling according to the present invention.

FIG. 2 is a cross-sectional view illustrating one example of applying a faucet coupling according to the present invention.

FIG. 3 is a cross-sectional view illustrating another example of applying a faucet coupling according to the present invention.

FIGS. 4a and 4b are views illustrating a process of inserting a fixture into an exhaust tube of a faucet in a faucet coupling according to the present invention.

### DETAILED DESCRIPTION OF THE INVENTION

Reference will now be made in detail to preferred embodiments of the present invention, examples of which are illustrated in the accompanying drawings.

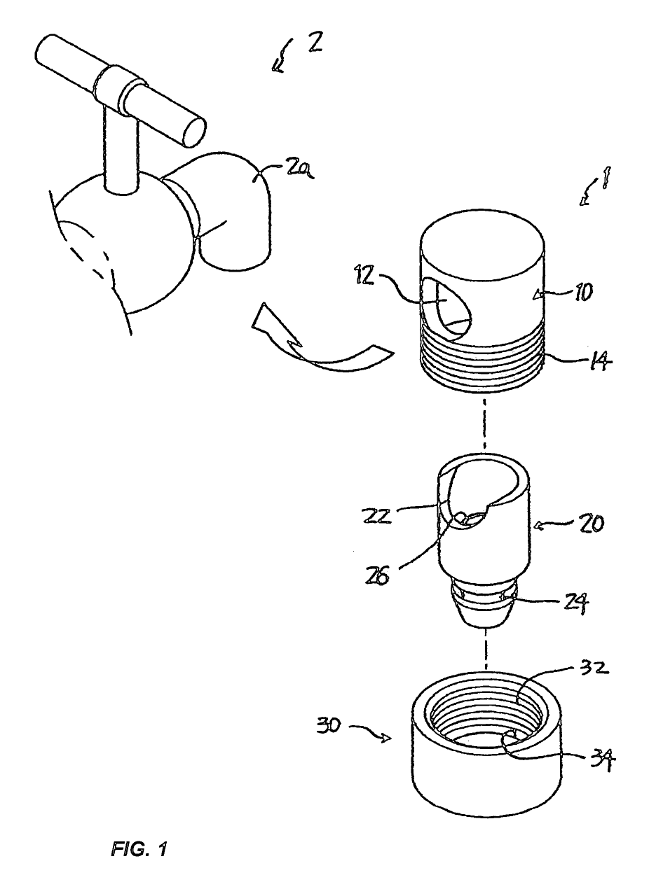

FIG. 1 is an exploded perspective view of a faucet coupling according to the present invention. The faucet coupling includes a connector 20 for coupling a tube or adaptor with a faucet, and a male coupler 10 and a female coupler 30 for fastening the connector 20 to a faucet.

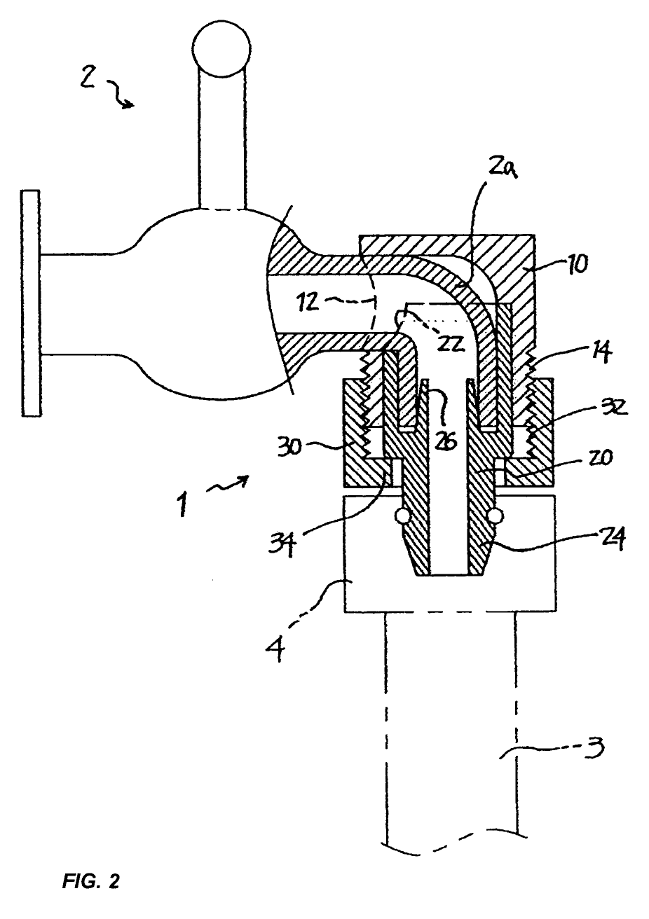

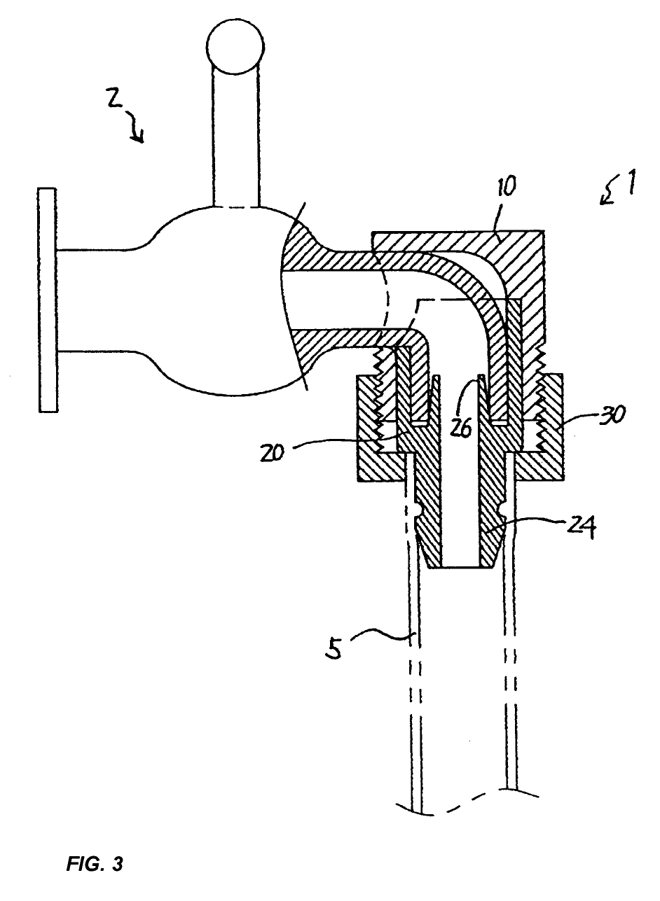

FIG. 2 is a cross-sectional view illustrating one example of applying the faucet coupling according to the present invention, in which an end of the connector 20 is coupled to an adaptor provided to a tube of a washing machine. FIG. 3 is a cross-sectional view illustrating another example of applying the faucet coupling according to the present invention, in which the end of the connector 20 is coupled to a general tube.

The faucet coupling will now be described in detail with reference to the accompanying drawings.

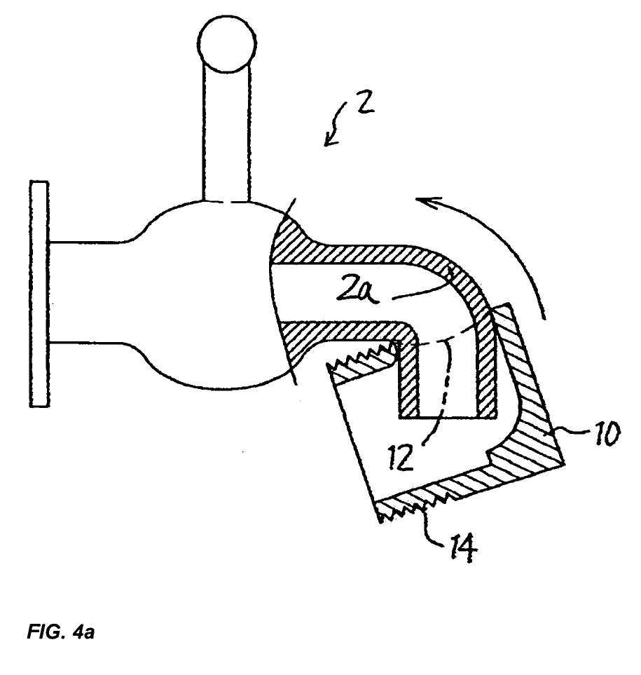

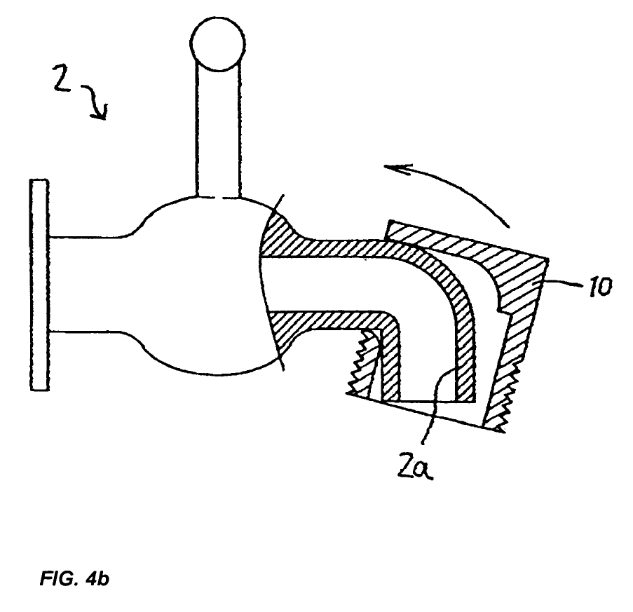

The male coupler 10 is assembled to an outer periphery of a discharge pipe 2a of a faucet 2, and has a closed cylindrical upper portion, an opened cylindrical bottom, and an opening 12 formed at a side wall for receiving the discharge pipe 2a of the faucet 2. The opening 12 has a diameter sufficient for deeply receiving the discharge pipe 2a bent at a right angle, as shown in FIGS. 4a and 4b. More particularly, the discharge pipe 2a of the faucet is vertically bent to have an L shape, and the male coupler 10 is assembled to an outer periphery of the discharge pipe in an upright posture. Accordingly, the male coupler 10 is obliquely fitted into the discharge pipe, as shown in FIG. 4a, and then is gradually rotated to have an upright posture, as shown in FIG. 4b. The male coupler 10 is provided on a lower outer periphery thereof with a threaded portion 14.

The connector 20 is interposed between the discharge pipe 2a and the male coupler 10, and has an opened cylindrical upper portion. The discharge pipe 2a is inserted into an inner periphery of the connector 20, and the male coupler 10 accommodates an outer periphery of the connector 20. The connector 20 is formed with a slot 22 at an upper portion thereof corresponding to the opening 12 of the male coupler 10, so that the discharge pipe 2a is fitted into an interior of the connector 20. Also, the connector 20 has a fitting portion 24 formed at a lower portion of the connector, of which a diameter is gradually decreased toward the lower portion, and the fitting portion 24 is coupled to the adaptor 4 provided to an end of the tube. In addition, the connector 20 has a sealing 26 protruded from a middle portion of the connector, so that the sealing is tightly contacted with an inner periphery of the discharge pipe 2a when the coupling is assembled to the faucet. The sealing 26 is tapered so that a lower portion thereof is thicker than an upper portion. This construction improves a sealing performance.

The cylindrical female coupler 30 is fastened to the lower portion of the male coupler 10 and the connector 20. The female coupler 30 is provided on an inner periphery thereof with a threaded portion 32 which is engaged to the threaded portion 14 of the male coupler 10. Also, the female coupler 30 has a circular rim 34 formed at a lower inside and having a diameter smaller than the outer periphery of the connector 20. The connector 20 is seated on the rim 34, and the fitting portion 24 of the connector 20 passes through the rim 34 to protrude downward.

A process of installing the faucet coupling according to the present invention will now be described.

First, the male coupler 10 is installed to the discharge pipe 2a of the faucet as shown in FIGS. 4a and 4b, and the connector 20 is fitted between the discharge pipe 2a and the male coupler 10, with the sealing 26 being inserted into the inner periphery of the discharge pipe 2a. After that, the female coupler 30 is threadedly engaged to the male coupler 10 by rotating the female coupler. When the female coupler 30 is moved upward against the male coupler 10, the connector 20 seated on the rim of the female coupler 30 is also moved upward. Accordingly, the sealing 26 is closely contacted with the inner periphery of the discharge pipe 2a to completely seal the connection between the faucet and the connector, as shown in FIG. 2.

The fitting portion 24 exposed downward is mounted to the adaptor 4 provided to a conventional tube of the washing machine or water spraying machine, thereby strongly connecting the faucet and the tube without water leakage.

When connecting a common tube, a tube 5 is fitted into the fitting portion 24 of the connector 20, and the female coupler 30 is strongly fastened, thereby firmly tightening the outer periphery of the tube and the rim 34 of the female coupler.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

As apparent from the above description, the present invention can easily and quickly install or uninstall the coupling to the faucet without using separate tools. Also, the coupling is simple and inexpensive, and can keep watertight at the connection.

What is claimed is:

1. A coupling faucet comprising:
a male coupler 10 installed to an outer periphery of a discharge pipe of a faucet, and having a closed cylindrical upper portion, an opened cylindrical bottom, and an opening 12 formed at a side wall for receiving the discharge pipe of the faucet;
a connector 20 interposed between the discharge pipe and the male coupler, and having an opened cylindrical upper portion, a slot 22 formed at an upper portion thereof corresponding to the opening 12 of the male coupler 10 for receiving the discharge pipe, and a fitting portion 24 formed at a lower portion of the connector to be coupled to a tube; and
a cylindrical female coupler 30 provided on an inner periphery thereof with a threaded portion 32 which is engaged to a threaded portion 14 of the male coupler 10, and having a circular rim 34 formed at a lower inside.

2. The coupling faucet as claimed in claim 1, wherein the connector 20 has a sealing 26 protruded from a middle portion of the connector, so that the sealing is tightly contacted with an inner periphery of the discharge pipe when the coupling is assembled to the faucet.
